(19) United States
(12) Patent Application Publication
(10) Pub. No.: US 2021/0064917 A1
(43) Pub. Date: Mar. 4, 2021

(54) METHOD FOR MEASURING AIRPORT FLIGHT WAVEFORM SIMILARITY BY SPECTRAL CLUSTERING BASED ON TREND DISTANCE

(71) Applicant: Nanjing University of Aeronautics and Astronautics, Nanjing (CN)

(72) Inventors: Zheng ZHAO, Nanjing (CN); Chencheng XU, Nanjing (CN); Jiaming GE, Nanjing (CN); Changcheng LI, Nanjing (CN); Minghua HU, Nanjing (CN)

(21) Appl. No.: 17/004,469

(22) Filed: Aug. 27, 2020

(30) Foreign Application Priority Data
Aug. 27, 2019 (CN) 201910794196.9

(51) Int. Cl. G06K 9/62; G08G 5/00

(52) U.S. Cl. CPC G06K 9/6224; G08G 5/0043; G08G 5/0026; G06K 9/6267

(57) ABSTRACT

The present invention discloses a method for measuring an airport flight waveform similarity by spectral clustering based on a trend distance. This method first transforms arrival and departure flight wave series of airports into trend series by using a time series trend symbolization method, and then measures the similarity of the arrival and departure flight waves of different airports by using spectral clustering based on a trend distance. The present invention realizes the purpose of scientific determination of the airport's transfer capacity and functional orientation from the demand level. Compared with those adopting empirical identification and evaluation indicator comparison, the airport classification method of the present invention is more reasonable and objective.

### CROSS-REFERENCE TO RELATED APPLICATION

This application claims the benefit of priority through the Paris Convention to Chinese application 201910794196. 9, filed Aug. 27, 2019.

### TECHNICAL FIELD

The present invention relates to a method for measuring an airport flight waveform similarity by spectral clustering based on a trend distance, and belongs to the technical field of airport operation similarity measurement.

### BACKGROUND

Flight wave is the quantitative distribution curve of the arrival/departure flights of the airport over time, which effectively reflects the market demand and operating characteristics of the airport. A hub airport with a high transfer rate often arranges arrival flights in one time period and departure flights in the adjacent time period, so as to effectively distinguish and connect the arrival and departure flights in terms of time. Therefore, the arrival and departure flight waves of the hub airport tend to show a zigzag waveform and cross with each other.

In China, as the demand for airport passenger transportation and the number of flights increase year by year, many airports are expected to transform from regional branch airports to large hub airports. To build an airport into a strong transit hub, one of the core steps is to construct an adaptive flight wave. Therefore, the in-depth study of the flight wave, especially the measurement of similarity in the flight waves of large airports, is of great significance for determining the transfer capability, current functional orientation and future strategic development direction of the airports.

At present, the global airport flight waves are roughly divided into zigzag flight waves, trapezoidal flight waves, morning and evening peak waves and superimposed flight waves according to their shapes by experience identification and evaluation indicator comparison. The classification methods are not mature. The experience identification method is not objective. The evaluation indicator comparison method extract and compare the density, amplitude and peak takeoff and landing interval to evaluate the similarity of the flight waves. This method pays attention to the local characteristics of the flight wave, but ignores the variation trend of the waveform. As a result, it is unable to carry out unified, comprehensive measurement of similarity in the airport flight waves, leading to the mismatch between the macro operation decision-making including the airport flight schedule and the actual demand of the airport.

### SUMMARY

A technical problem to be solved by the present invention is to provide a method for measuring an airport flight waveform similarity by spectral clustering based on a trend distance. The present invention realizes the measurement of flight waveform similarity by symbolizing arrival and departure flight wave series, and classifying arrival and departure flight waveforms by spectral clustering according to a trend distance.

To achieve the above purpose, the present invention provides the following technical solution.

A method for measuring an airport flight waveform similarity by spectral clustering based on a trend distance includes the following steps:
step 1: performing statistics on flight data of airports to be classified, according to a Chinese flight time coordination system, where there are k airports to be classified, and the flight data of each airport to be classified include a number of arrival flights landing at the airport every natural hour during a statistical time period;
step 2: calculating an average number of arrival flights every natural hour on a natural day according to the flight data of the airports to be classified; plotting an arrival flight wave of each airport to be classified by using a number of natural hours as an abscissa and the average number of arrival flights every natural hour as an ordinate;
step 3: regarding the arrival flight wave of each airport to be classified as an arrival flight wave series A={A₁, A₂, . . . , A₂₄} with a length of 24, and transforming the arrival flight wave series into an arrival trend series v={v₁, v₂, . . . , v₂₂} according to variation trend characteristics thereof;
step 4: calculating an arrival trend distance between arrival trend series of any two airports to be classified, according to a dynamic programming algorithm; and
step 5: constructing an arrival trend matrix based on the arrival trend distance, performing spectral clustering on the arrival trend matrix, and classifying airports with similar arrival flight waves into one category, to obtain a classification result.

Further preferably, step 3 specifically includes the following process:
step 3.1: classifying variation trends of the arrival flight wave series into 9 categories including continuous decline, steady after decline, trough, decline after steady, continuous steady, rise after steady, crest, steady after rise and continuous rise according to variation trend characteristics, and corresponding the 9 trends to letters A to I in sequence;
step 3.2: calculating R(A,i) according to the following formulas:

$${X}_{max} = {argmax}_{{A}_{i} , {A}_{i + 1} ∈ A} \vert {A}_{i} - {A}_{i + 1} \vert$$

$$R ( A , i ) = \frac{{A}_{i} - {A}_{i + 1}}{{X}_{max}} , i = 1 , 2 , ⋯ , 23$$

step 3.3: determining the flight wave variation trend vⱼ by R(A,i) and R(A,i+1), j=1, 2, . . . , 22 and transforming the arrival flight series into an arrival trend series based on the following rules:

| νⱼ | R(A, i + 1) > ε | \|R(A, i + 1)\| ≤ ε | \|R(A, i + 1)\| < −ε |
|---|---|---|---|
| R(A, i) > ε | A | B | C |
| \|R(A, i)\| ≤ ε | D | E | F |
| \|R(A, i)\| < −ε | G | H | I |

where, Aᵢ and Aᵢ₊₁ in the arrival flight wave series A represent an average number of arrival flights in i-th and (i+1)-th natural hours, respectively; Xₘₐₓ represents a maximum absolute value of a difference between corresponding average numbers of arrival flights in two adjacent natural hours; ϵ=0.05.

Further preferably, the spectral clustering in step 5 specifically includes the following process:
step 5.1: constructing an arrival trend matrix S_{A} according to the arrival trend distance:

$${S}_{A} = ( \begin{matrix}{TDA}_{11} & ⋯ & {TDA}_{1 k} \\ ⋮ & ⋱ & ⋮ \\ {TDA}_{k 1} & ⋯ & {TDA}_{kk}\end{matrix} )$$

where, TDAₗₖ represents an arrival trend distance between arrival trend series of the 1^{st} airport and a k-th airport; TDAₖ₁ represents an arrival trend distance between arrival trend series of the k-th airport and the 1^{st} airport; TDAₖₖ represents an arrival trend distance between arrival trend series of the same airport;
step 5.2: constructing an adjacency matrix W and a degree matrix D according to the arrival trend matrix S_{A};
step 5.3: calculating a Laplacian matrix L, and standardizing L to obtain a standardized matrix D^{-1/2}LD^{-1/2};
step 5.4: calculating eigenvalues of the matrix D^{-1/2}LD^{-1/2}, sorting the eigenvalues from small to large, and taking first k₁ eigenvalues to solve corresponding eigenvectors;
step 5.5: composing the eigenvectors corresponding to the k₁ eigenvalues into a matrix, and standardizing by rows to obtain an eigenmatrix F; and
step 5.6: clustering each row of the eigenmatrix F as a sample by using a K-means clustering method, to obtain a clustering result.

A method for measuring an airport flight waveform similarity by spectral clustering based on a trend distance includes the following steps:
step 1: performing statistics on flight data of airports to be classified, according to a Chinese flight time coordination system, where there are k airports to be classified, and the flight data of each airport to be classified include a number of departure flights taking off from the airport every natural hour during a statistical time period;
step 2: calculating an average number of departure flights every natural hour on a natural day according to the flight data of the airports to be classified; plotting a departure flight wave of each airport to be classified by using a number of natural hours as an abscissa and the average number of departure flights every natural hour as an ordinate;
step 3: regarding the departure flight wave of each airport to be classified as a departure flight wave series A={A₁, A₂, . . . , A₂₄} with a length of 24, and transforming the departure flight wave series into a departure trend series v={v₁, v₂, . . . , v₂₂} according to variation trend characteristics thereof;
step 4: calculating a departure trend distance between departure trend series of any two airports to be classified, according to a dynamic programming algorithm; and
step 5: constructing a departure trend matrix based on the departure trend distance, performing spectral clustering on the departure trend matrix, and classifying airports with similar departure flight waves into one category, to obtain a classification result.

A method for measuring an airport flight waveform similarity by spectral clustering based on a trend distance includes the following steps:
step 1: performing statistics on flight data of airports to be classified, according to a Chinese flight time coordination system, where there are k airports to be classified, and the flight data of each airport to be classified include a number of arrival flights and a number of departure flights of the airport every natural hour during a statistical time period;
step 2: calculating an average number of arrival flights and an average number of departure flights every natural hour on a natural day according to the flight data of the airports to be classified; plotting an arrival flight wave and a departure flight wave of each airport to be classified by using a number of natural hours as an abscissa and the average number of arrival flights and the average number of departure flights every natural hour as an ordinate;
step 3: regarding the arrival flight wave and the departure flight wave of each airport to be classified as an arrival flight wave series and a departure flight wave series with a length of 24, and transforming the arrival flight wave series and the departure flight wave series into an arrival trend series and a departure trend series according to variation trend characteristics thereof;
step 4: calculating an arrival trend distance between arrival trend series of any two airports to be classified and a departure trend distance between departure trend series of the two airports to be classified, according to a dynamic programming algorithm; and
step 5: constructing an arrival trend matrix and a departure trend matrix based on the arrival trend distance and the departure trend distance; superimposing the arrival trend matrix and the departure trend matrix to obtain a general trend matrix; performing spectral clustering on the general trend matrix, and classifying airports with similar flight waves into one category, to obtain a classification result.

Compared with the prior art, the present invention provides the following technical effects:
1. The present invention simplifies the traditional SMVT algorithm (a time series similarity measurement method) and applies it to the field of airport flight wave analysis. The present invention transforms the airport flight wave into a trend series to symbolize the shape characteristics of the airport flight wave, and quantitatively measures the similarity in the shape of the airport flight wave. Compared with the existing methods through empirical identification and evaluation indicator comparison, the airport flight wave classification method of the present invention is more reasonable and objective.
2. The present invention introduces the concept of trend distance to the field of airport flight waves. The present invention uses the trend distance to characterize the similarity of the airport flight wave in terms of shape and variation trend, thereby obtaining an indicator to quantitatively compare the similarity in the flight wave distribution of different airports.

### BRIEF DESCRIPTION OF DRAWINGS

FIG. 1 is a flowchart of a method for measuring an airport flight waveform similarity by spectral clustering based on a trend distance according to the present invention.

FIG. 2 is a schematic waveform of an airport flight wave.

FIG. 3 is a schematic diagram of a symbolic expression process of a trend of an airport flight wave series.

FIG. 4 is a heat map of similarity of airport flight waves based on a trend distance according to an example of the present invention.

### DETAILED DESCRIPTION

The implementations of the present invention are described in detail below with reference to the accompanying drawings. The reference numerals of the implementations are shown in the accompanying drawings. The implementations are exemplary, and are merely intended to explain the present invention, rather than to constitute a limitation to the present invention.

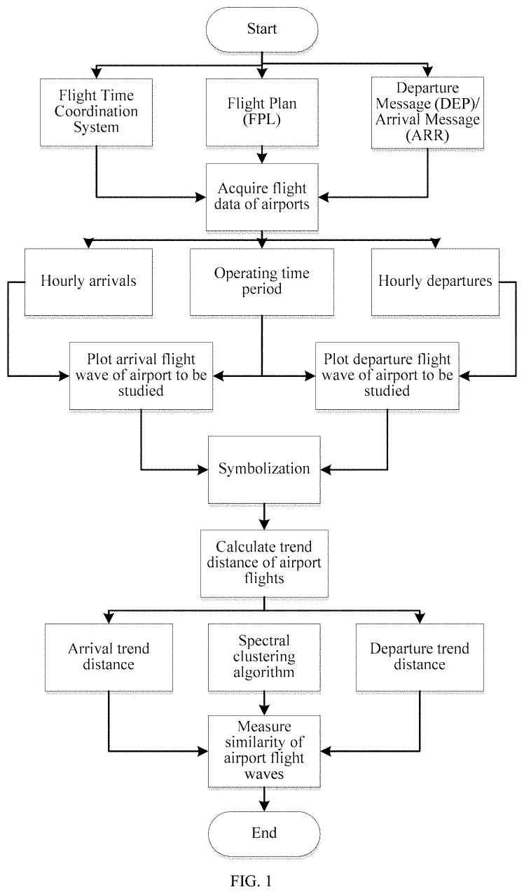

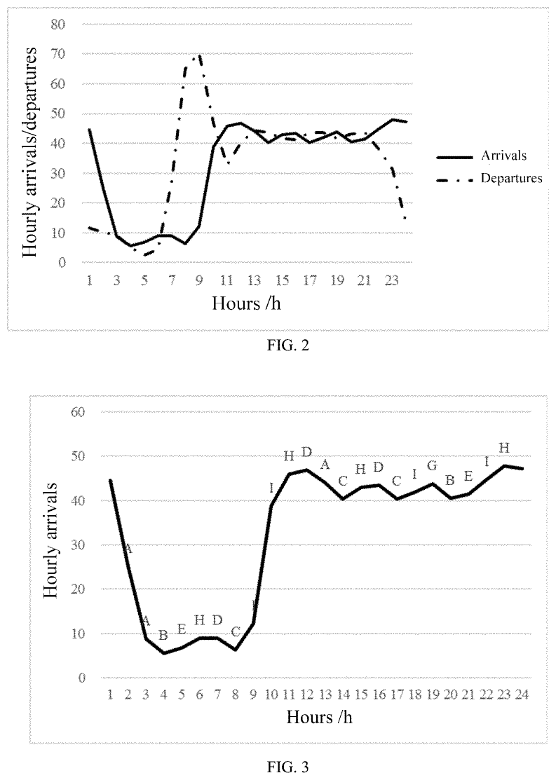

The present invention provides a method for measuring an airport flight waveform similarity by spectral clustering based on a trend distance. As shown in FIG. 1, the method specifically includes the following steps:
Step 1: Acquire flight data of airports to be classified. The raw data are derived from a Chinese flight time coordination system, the planned time schedule of the flight plan (FPL) and the records of the departure message (DEP) and arrival message (ARR) sent after actual departure and arrival. These data encompass the flight time data of all airports in China in a selected time period, for example, flight number, departure and arrival airports, departure and arrival times and aircraft type in the flight schedule; departure and arrival airports, departure and arrival times, aircraft type and aircraft registration number on the execution day of FPL; and actual departure and arrival airports, actual departure and arrival times, actual taxi-out time and flight status recorded after actual operation, etc.
Step 2: Preprocess the flight plan data of a selected airport. First, the data of arrival, departure and taxi-out times of the selected airport as the departure airport and arrival airport are filtered out. Then, by taking time as the search condition, the number of arrival flights at the selected airport as the arrival airport and the number of flights at the selected airport as the departure airport in every hour of a selected time period are filtered out based on filter conditions. The operating time period of each set of data is recorded. In the statistical process, if there are any missing flight time data, a skip operation is executed to ensure the reliability of the data to the greatest extent. Thus, each set of data to be studied includes the valid information, namely operating time period information, hourly arrivals and hourly departures, which are helpful for the subsequent research. Specifically:
Step 2.1: Select an airport.
Step 2.2: Read flight plan data samples in sequence.
Step 2.3: If one of the departure and arrival airports of a read flight plan data sample is the selected airport, proceed to Step 2.4; otherwise, proceed to Step 2.2.
Step 2.5: If the departure and arrival times related to the selected airport in the read flight plan data sample are valid, proceed to Step 2.5; otherwise, proceed to Step 2.2.
Step 2.5: Determine a unit time period of a relevant time in the read flight plan data sample, and distinguish according to different unit time periods; if there is an unread flight plan data sample, proceed to Step 2.2; otherwise, proceed to Step 2.6.
Step 2.6: Count a number of departures/arrivals in each unit time period.
Step 2.7: End the processing.
Step 3. Plot a flight wave of the studied airport. First, the operating time period, hourly arrivals and hourly departures of the selected airport in Step 2 are integrated and processed. Since the airport's arrival and departure flights are regularly distributed on a daily basis, only the 24-hour airport arrival and departure flight data of a natural day are needed to plot the airport's arrival and departure flight waves. In order to eliminate errors and make the subsequent research universally significant, the present invention chooses a data set within one year. The average annual number of arrival flights and average annual number of departure flights of the studied airport in every hour are calculated. Two polyline flight waves are plotted by using the operating hours as an abscissa and the average annual number of arrival/departure flights as an ordinate, as shown in FIG. 2. In the figure, a solid line represents an arrival flight wave, and a dashed line represents a departure flight wave.
Step 4: Symbolize trends of an airport flight wave series. The present invention applies an SMVT algorithm (a time series similarity measurement method) to the field of airport flight wave analysis, and symbolizes the airport flight wave according to its variation trend characteristics. The overall idea of the SMVT method includes: equal-length processing of the time series with segmentation aggregation approximation as a transformation function, symbolization of series data (TSM) according to the variation trends of the time series, and calculation of trend distance between different trend series. In the present invention, the airport flight wave studied is essentially an equal-time series with a length of 24 natural hour slices, so the SMVT algorithm can be simplified to directly symbolize the series. The time series are transformed to trend series and a trend distance between the series is calculated. Through analysis, the actual variation trends of the airport flight wave series are summarized into 9 categories, namely TF={continuous decline, steady after decline, trough, decline after steady, continuous steady, rise after steady, crest, steady after rise, continuous rise}. The 9 trends are sequentially corresponded to 9 letters in a set of {A-I}, so TF={A,B,C,D,E,F,G,H,I}.

The flight waves of the airport are regarded as two fixed-length series with a length of 24 natural hour slices. The arrival flight wave series is A={A₁, A₂, . . . , A₂₄}, where A₁, A₂, . . . , A₂₄ are the average annual number of arrival flights at the airport in every hour. The departure flight wave series of the airport is D={D₁, D₂, . . . , D₂₄}, where D₁, D₂, . . . , D₂₄ are the average annual number of departures at the airport in every hour. Xₘₐₓ is assumed to be a maximum difference between any two data Aᵢ, Aᵢ₊₁ (i=1, 2, . . . , 23) with adjacent subscripts in the arrival wave series A. Yₘₐₓ is a maximum difference between any two data Dᵢ, Dᵢ₊₁ (i=1, 2, . . . , 23) with adjacent subscripts in the departure wave series D. ϵ (0<ϵ<1) is a threshold used to distinguish the variation trends, which is 0.05 in the present invention.

Arrival flight wave series:

$${X}_{max} = {argmax}_{{A}_{i} , {A}_{i + 1} ∈ A} \vert {A}_{i} - {A}_{i + 1} \vert$$

$$R ( A , i ) = \frac{{A}_{i} - {A}_{i + 1}}{{X}_{max}} , i = 1 , 2 , ⋯ , 23$$

The variation trend vⱼ of the arrival flight wave is determined by two adjacent terms R(A,i) and R(A,i+1) i=1, 2, . . . , 23 j=1, 2, . . . , 22.

Departure flight wave series:

$${Y}_{max} = {argmax}_{{D}_{i} , {D}_{i + 1} ∈ D} \vert {D}_{i} - {D}_{i + 1} \vert$$

$$R ( D , i ) = \frac{{D}_{i} - {D}_{i + 1}}{{Y}_{max}} , i = 1 , 2 , ⋯ , 23$$

The variation trend vⱼ of the departure flight wave is determined by two adjacent terms R(D,i) and R(D,i+1) i=1, 2, . . . , 23, j=1, 2, . . . , 22

The symbolized coding rules of the variation trend vⱼ∈TF corresponding to the arrival and departure flight wave series are shown in Table 1.

TABLE 1
Trend-based flight wave symbolization coding rules

| νⱼ | R(A, i + 1) > ε | \|R(A, i + 1)\| ≤ ε | \|R(A, i + 1)\| < −ε |
|---|---|---|---|
| R(A, i) > ε | A | B | C |
| \|R(A, i)\| ≤ ε | D | E | F |
| \|R(A, i)\| < −ε | G | H | I |

Obviously, every arrival/departure flight wave with a fixed length of 24 natural hours can be transformed into a trend series v={v₁, v₂, . . . , v₂₂} with a length of 22 according to the trend-based flight wave symbolization coding rules. FIG. 3 shows a schematic diagram of the symbolization process.

Step 5: Calculate a trend distance of airport flights. For the arrival flight waves of any two airports, v_{A1}={v_{A11}, v_{A12}, . . . , v_{A1p}, . . . , v_{A1M}} (p=1, 2, . . . , M). v_{A2}={v_{A21}, v_{A22}, . . . , v_{A2q}, . . . , v_{A2N}} (q=1, 2, . . . , N) The arrival trend distance TDA₁₂ between the two airports is defined as follows:

$$Dist ( 0 , 0 ) = 0$$

$$Dist ( p , 0 ) = Dist ( p - 1 , 0 ) + {μ}_{d}$$

$$Dist ( 0 , q ) = Dist ( 0 , q - 1 ) + {μ}_{i}$$

$$Dist ( p , q ) = min \{ Dist ( p - 1 , q ) + {μ}_{d} , Dist ( p , q - 1 ) + {μ}_{i} , Dist ( p - 1 , q - 1 ) + {μ}_{r} ( p , q ) \}$$

$${σ}_{max} = max \{ \vert max ( {v}_{A 1} ) - min ( {v}_{A 2} ) \vert , \vert min ( {v}_{A 1} ) - max ( {v}_{A 2} ) \vert \}$$

$${m}_{r} ( p , q ) = \frac{\vert {v}_{A 1 p} - {v}_{A 2 q} \vert}{{s}_{max}}$$

$${TDA}_{12} = Dist ( M , N )$$

Since the trend distance of the arrival flights waves of the two airports is an equal-length series with a length of 22, M=N=22, μ_{d}, μᵢ and μᵣ(p, q) are the cost of insert, delete and replace operations, respectively; μ_{d}=uᵢ=1. In the same way, a departure trend distance TDD₁₂ between the departure trend series V_{D1} and V_{D2} of two airports can be calculated.

In fact, in the above dynamic programming algorithm, the trend distance TD between the two trend series is obtained by calculating a minimum edit cost for transforming the trend series v_{A1} to the trend series v_{A2}.

Assuming that there are k airports (1,2,3, . . . , k) to be studied, then:

$${S}_{A} = ( \begin{matrix}{TDA}_{11} & ⋯ & {TDA}_{1 k} \\ ⋮ & ⋱ & ⋮ \\ {TDA}_{k 1} & ⋯ & {TDA}_{kk}\end{matrix} )$$

$${S}_{D} = ( \begin{matrix}{TDD}_{11} & ⋯ & {TDD}_{1 k} \\ ⋮ & ⋱ & ⋮ \\ {TDD}_{k 1} & ⋯ & {TDD}_{kk}\end{matrix} )$$

In this way, by performing spectral clustering on S_{A}, airports with similar arrival flight waves are classified into one category. Similarly, S_{D} includes the similarity of departure flight waves between airports. The spectral clustering specifically includes the following steps:
Step 1: Obtain a trend matrix S.
Step 2: Construct an adjacency matrix W and construct a degree matrix D according to the trend matrix S.
Step 3: Calculate a Laplacian matrix L.
Step 4: Standardize L to obtain a standardized Laplacian matrix D^{-1/2}LD^{-1/2}.
Step 5: Calculate eigenvectors ƒ corresponding to the smallest k₁ eigenvalues of D^{-1/2}LD_{-1/2}, where k₁ is a hyperparameter that can be set arbitrarily.
Step 6: Standardize a matrix composed of the eigenvectors ƒ by rows, and finally obtain an n×k₁-dimensional eigenmatrix F, where n is a length of the eigenvector.
Step 7: Cluster each row of F as a k₁-dimensional sample by using an input clustering method, where there are a total of n samples and k₂ clusters; k₂ is a value that can be set arbitrarily to determine the accuracy of clustering.
Step 8: Cluster and classify, C(c₁, c₂, . . . , cₖ_{₂}).

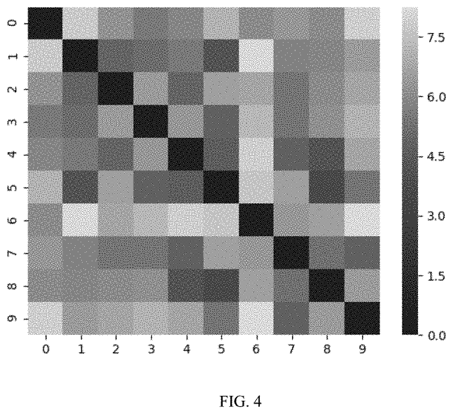

FIG. 4 is an intuitive heat map of the similarity of arrival flight waves of 10 airports based on the spectral clustering algorithm. In the heat map, the color corresponds to the similarity value. A darker color indicates a higher similarity of the arrival flight waves between two airports. In the same way, the above operations are performed on the departure trend matrix S_{D} to obtain the similarity in the departure flight waves of the departure airport. Table 2 shows the similarity clustering results of airport arrival and departure flight waves when k₂=3, that is, when the final clustering results are classified into three categories. 0, 1 and 2 are used to represent the clustering results of the three categories, respectively.

Table 2 Clustering results of similarity of airport arrival and departure flight waves when k₂=3

| Airport | ZLXY | ZSSS | ZBAA | ZPPP | ZUUU | ZUCK | ZSPD | ZGGG | ZSHC | ZGSZ |
|---|---|---|---|---|---|---|---|---|---|---|
| Arrival | 2 | 1 | 0 | 1 | 0 | 2 | 0 | 0 | 2 | 0 |
| Departure | 1 | 1 | 0 | 1 | 0 | 2 | 0 | 0 | 2 | 0 |

The spectral clustering algorithm can be used for separate and comprehensive research on the airport arrival flight wave and airport departure flight wave. The comprehensive processing is to superimpose the arrival trend matrix S_{A} and the departure trend matrix S_{D} to obtain a general trend matrix S_{general} (S_{general}=S_{A}+S_{D}) as a trend matrix S of the input spectrum clustering algorithm. In this way, it is possible to conduct a unified and comprehensive study on the similarity of the airport's arrival and departure flight waves from the macro-demand level.

The above examples are merely intended to illustrate the technical ideas of the present invention, rather than to limit the protection scope of the present invention. Any variations made on the basis of the technical solutions according to the technical ideas of the present invention should fall within the protection scope of the present invention.

1. A method for measuring an airport flight waveform similarity by spectral clustering based on a trend distance, comprising the following steps:
step 1: performing statistics on flight data of airports to be classified, according to a Chinese flight time coordination system, wherein there are k airports to be classified, and the flight data of each airport to be classified comprise a number of arrival flights landing at the airport every natural hour during a statistical time period;
step 2: calculating an average number of arrival flights every natural hour on a natural day according to the flight data of the airports to be classified; plotting an arrival flight wave of each airport to be classified by using a number of natural hours as an abscissa and the average number of arrival flights every natural hour as an ordinate;
step 3: regarding the arrival flight wave of each airport to be classified as an arrival flight wave series A={A₁, A₂, . . . , A₂₄} with a length of 24, and transforming the arrival flight wave series into an arrival trend series v={v₁, v₂, . . . , v₂₂} according to variation trend characteristics thereof;
step 4: calculating an arrival trend distance between arrival trend series of any two airports to be classified, according to a dynamic programming algorithm; and
step 5: constructing an arrival trend matrix based on the arrival trend distance, performing spectral clustering on the arrival trend matrix, and classifying airports with similar arrival flight waves into one category, to obtain a classification result.

2. The method for measuring an airport flight waveform similarity by spectral clustering based on a trend distance according to claim 1, wherein step 3 specifically comprises the following process:
step 3.1: classifying variation trends of the arrival flight wave series into 9 categories comprising continuous decline, steady after decline, trough, decline after steady, continuous steady, rise after steady, crest, steady after rise and continuous rise according to variation trend characteristics, and corresponding the 9 trends to letters A to I in sequence;
step 3.2: calculating R(A, i) according to the following formulas:
$${X}_{max} = {argmax}_{{A}_{i} , {A}_{i + 1} ∈ A} \vert {A}_{i} - {A}_{i + 1} \vert$$
$$R ( A , i ) = \frac{{A}_{i} - {A}_{i + 1}}{{X}_{max}} , i = 1 , 2 , ⋯ , 23$$
step 3.3: determining the flight wave variation trend vⱼ by R(A,i) and R(A,i+1), j=1, 2, . . . , 22, and transforming the arrival flight series into an arrival trend series based on the following rules:

| νⱼ | R(A, i + 1) > ε | \|R(A, i + 1)\| ≤ ε | \|R(A, i + 1)\| < −ε |
|---|---|---|---|
| R(A, i) > ε | A | B | C |
| \|R(A, i)\| ≤ ε | D | E | F |
| \|R(A, i)\| < −ε | G | H | I |

wherein, Aᵢ and Aᵢ₊₁ in the arrival flight wave series A represent an average number of arrival flights in i-th and (i+1)-th natural hours, respectively; Xₘₐₓ represents a maximum absolute value of a difference between corresponding average numbers of arrival flights in two adjacent natural hours; ϵ=0.05.

3. The method for measuring an airport flight waveform similarity by spectral clustering based on a trend distance according to claim 1, wherein the spectral clustering in step 5 specifically comprises the following process:
step 5.1: constructing an arrival trend matrix S_{A} according to the arrival trend distance:
$${S}_{A} = ( \begin{matrix}{TDA}_{11} & ⋯ & {TDA}_{1 k} \\ ⋮ & ⋱ & ⋮ \\ {TDA}_{k 1} & ⋯ & {TDA}_{kk}\end{matrix} )$$
wherein, TDA₁ₖ represents an arrival trend distance between arrival trend series of the 1^{st} airport and a k-ₜₕ airport; TDAₖ₁ represents an arrival trend distance between arrival trend series of the k-th airport and the 1^{st} airport; TDAₖₖ represents an arrival trend distance between arrival trend series of the same airport;
step 5.2: constructing an adjacency matrix W and a degree matrix D according to the arrival trend matrix S_{A};
step 5.3: calculating a Laplacian matrix L, and standardizing L to obtain a standardized matrix D^{-1/2}LD^{-1/2};
step 5.4: calculating eigenvalues of the matrix D^{-1/2}LD^{-1/2}, sorting the eigenvalues from small to large, and taking first k₁ eigenvalues to solve corresponding eigenvectors;
step 5.5: composing the eigenvectors corresponding to the k₁ eigenvalues into a matrix, and standardizing by rows to obtain an eigenmatrix F; and
step 5.6: clustering each row of the eigenmatrix F as a sample by using a K-means clustering method, to obtain a clustering result.

4. A method for measuring an airport flight waveform similarity by spectral clustering based on a trend distance, comprising the following steps:
step 1: performing statistics on flight data of airports to be classified, according to a Chinese flight time coordination system, wherein there are k airports to be classified, and the flight data of each airport to be classified comprise a number of departure flights taking off from the airport every natural hour during a statistical time period;
step 2: calculating an average number of departure flights every natural hour on a natural day according to the flight data of the airports to be classified; plotting a departure flight wave of each airport to be classified by using a number of natural hours as an abscissa and the average number of departure flights every natural hour as an ordinate;
step 3: regarding the departure flight wave of each airport to be classified as a departure flight wave series A={A₁, A₂, . . . , A₂₄} with a length of 24, and transforming the departure flight wave series into a departure trend series v={v₁, v₂, . . . v₂₂} according to variation trend characteristics thereof;
step 4: calculating a departure trend distance between departure trend series of any two airports to be classified, according to a dynamic programming algorithm; and
step 5: constructing a departure trend matrix based on the departure trend distance, performing spectral clustering on the departure trend matrix, and classifying airports with similar departure flight waves into one category, to obtain a classification result.

5. A method for measuring an airport flight waveform similarity by spectral clustering based on a trend distance, comprising the following steps:
step 1: performing statistics on flight data of airports to be classified, according to a Chinese flight time coordination system, wherein there are k airports to be classified, and the flight data of each airport to be classified comprise a number of arrival flights and a number of departure flights of the airport every natural hour during a statistical time period;
step 2: calculating an average number of arrival flights and an average number of departure flights every natural hour on a natural day according to the flight data of the airports to be classified; plotting an arrival flight wave and a departure flight wave of each airport to be classified by using a number of natural hours as an abscissa and the average number of arrival flights and the average number of departure flights every natural hour as an ordinate;
step 3: regarding the arrival flight wave and the departure flight wave of each airport to be classified as an arrival flight wave series and a departure flight wave series with a length of 24, and transforming the arrival flight wave series and the departure flight wave series into an arrival trend series and a departure trend series according to variation trend characteristics thereof;
step 4: calculating an arrival trend distance between arrival trend series of any two airports to be classified and a departure trend distance between departure trend series of the two airports to be classified, according to a dynamic programming algorithm; and
step 5: constructing an arrival trend matrix and a departure trend matrix based on the arrival trend distance and the departure trend distance; superimposing the arrival trend matrix and the departure trend matrix to obtain a general trend matrix; performing spectral clustering on the general trend matrix, and classifying airports with similar flight waves into one category, to obtain a classification result.
